(19) United States
(12) Patent Application Publication
(10) Pub. No.: US 2004/0264756 A1
(43) Pub. Date: Dec. 30, 2004

(54) Self-learning method for image preparation of digital x-ray images

(76) Inventor: Martin Spahn, Erlangen (DE)

Correspondence Address: SCHIFF HARDIN, LLP, PATENT DEPARTMENT, 6600 SEARS TOWER, CHICAGO, IL, 60606-6473, US

(21) Appl. No.: 10/856,396

(22) Filed: May 28, 2004

(30) Foreign Application Priority Data
May 30, 2003 (DE) 103 24 908.7

(51) Int. Cl. G06K 9/00

(52) U.S. Cl. 382/132

(57) ABSTRACT

In a self-learning method for image preparation of digital x-ray images for automatic optimization of parameter settings for image preparation or in a digital x-ray apparatus, as well as an image processing unit and an x-ray apparatus operating according to the method, a predetermined modification is implemented on image data by at least one image processing module, dependent on at least one parameter. The parameter or parameters is/are supplied to the image processing module from a current parameter set which is initialized by a standard parameter set and which can be changed specific to a user. A copy of the modified current parameter set is stored given a positive confirmation of a change of the current parameter set, and an optimized parameter set is automatically determined using one or more stored copies. The standard parameter set is adapted to the optimized parameter set.

### BACKGROUND OF THE INVENTION

1. Field of the Invention

The present invention concerns a method for image preparation of digital x-ray images wherein a predetermined modification is implemented on image data in an image processing module, dependent on at least one parameter. The present invention furthermore refers to an image preparation unit to implement such a method and an x-ray apparatus incorporating the image preparation unit.

2. Description of the Prior Art

Digital x-ray detectors have been changing classical radiography, angiography and cardioangiography for some years. Various technologies for digital x-ray detection have been in use for a long time or are just about to become commercially available. Among these digital technologies are image intensifier camera systems based on television or CCD cameras, storage film systems with an integrated or external readout unit, selenium-based detectors with electrostatic readout, and solid-state detectors with active readout matrices with direct or indirect conversion of the x-ray radiation.

In contrast to classical radiography operating with x-ray films, in digital x-ray apparatuses the x-ray image exists in digital form, meaning in the form of image data. This enables the x-ray image to be prepared by electronic image processing before display on a screen, for example in order to make an organ to be examined or a sought pathological finding particularly well-visible in the medical application. Prevalent methods of digital image processing include the per-pixel application of characteristic lines for grey-value-dependent color or brightness modification of the x-ray image, filter operations such as the application of a low-pass, high-pass or median filter, frequency band-dependent filtering, contrast or brightness operations (also designated as windowing), and the like.

The abundance of available setting parameters normally allows the same raw image supplied by the x-ray detector to be prepared into final images that can significantly differ with regard to their optical appearance. The expected image appearance and the appearance that is believed to be optimal generally differ from radiologist to radiologist. This leads to individual adjustments with regard to the image preparation normally having to be effected in the installation of an x-ray system, in order to adapt the final images generated by the x-ray apparatus to the taste or the school of the x-ray department, or even to the individual radiologists. This adjustment process, which typically is implemented in the course of the installation of an x-ray apparatus in a collaboration of the technician implementing the installation with the provided users (thus radiologists or other application specialists), is in every case connected with significant effort. This is particularly due to different sets of image processing parameters having to be created for each organ (for example, thorax, hip, abdomen, skull, extremities, etc.) to be acquired by the x-ray apparatus, each projection (lateral, aperior-posterior, oblique, etc.), and possible generator settings (voltage, current, filtering, dose). In particular due to this complexity, the installation of a digital x-ray apparatus takes place in a protracted optimization process that is often dependent on the collective experience and idiosyncrasies of many users who will participate in the operation of the x-ray apparatus.

### SUMMARY OF THE INVENTION

An object of the present invention is to provide a method for image preparation of digital x-ray images in which an automatic optimization of the parameter settings ensues.

It is also an object of the present invention to provide an image preparation unit, as well as an x-ray apparatus incorporating such an image preparation unit, that allow a simplified installation.

The first object is inventively achieved by a method wherein at least one image processing module, which implements a predetermined modification of the image data dependent on at least one parameter, supplies the parameter or parameters from a current parameter set. This current parameter set includes a standard setting from a stored standard parameter set, but the current parameter set can be changed by a user in the course of manual post-processing of the x-ray image. If such a user-specific change of the current parameter set is positively acknowledged by the user, according to the method a copy of the changed current parameter set is stored. In a self-optimization step of the method, an optimized parameter set is determined using one or more such stored copies and is stored as a new standard parameter set.

With the inventive method, an iterative adaptation of the standard settings to the taste of the user, meaning to the radiologist working at the x-ray apparatus, is achieved. In fact, as long as the standard parameter set leads to an image processing that is unsatisfactory for the user, the user will frequently post-process the x-ray images produced by the x-ray apparatus by manual modification of the current parameter set. If a copy of each parameter set that has led to a successful image post-processing is saved, given frequent post-processing many such copies will be collected. Since the method optimizes its standard settings with regard to these copies, given continuous use of the x-ray apparatus, an image processing will be implemented that comes increasingly closer to the expectations of the user. Further manual changes by the user lead in the same manner to a refined adaptation of the standard settings to the expectation of the user. After a relatively short time, the user therefore will have only a slight inducement to manually post-process the x-ray images. Only a few copies of modified current parameter sets are stored, such that the standard settings henceforth remain largely unchanged in the optimized state. A decisive advantage of the method is that the optimization of the standard settings ensues automatically. The user thus can concentrate completely on the individual current x-ray image, while the optimization of the standard settings is implemented in the background.

A laborious adjustment process in the course of the installation of the x-ray apparatus is no longer necessary. Rather, after its installation, the x-ray apparatus requires only relatively little technical supervision.

The optimization of the standard settings preferably ensues by determining the parameter-specific average value of a number of stored copies and storing this as a new standard parameter set. The term “parameter-specific” as used herein means that only the parameters corresponding to one another of various copies are used for averaging. If the parameter set is formed by a two-dimensional field or a matrix of parameters Pᵢⱼ (i,j=1,2,3, . . . ), the parameter-specific average value <pᵢⱼ> of the parameters contained in the parameter set is determined according to the equation

$$⟨ {p}_{ij} ⟩ = \frac{1}{K} \cdot {\sum }_{k = 1}^{K} {p}_{ij}^{Nr . k} \qquad ( Eq . 1 )$$

wherein pᵢⱼ^{Nr.k} stands for the parameter pᵢⱼ contained in the k^{th} copy of the parameter set, and the sum is formed via a total number of k (k=1,2,3, . . . ) existing copies.

If the parameter set includes parameters pᵢⱼ(x) that are defined in the form of functions, the parameter-specific average value <pᵢⱼ(x)> calculates these parameters according to the equation

$$⟨ {p}_{ij} ( x ) ⟩ = \frac{1}{K} \cdot {\sum }_{k = 1}^{K} {p}_{ij}^{Nr . k} ( x ) \qquad ( Eq . 2 )$$

In order to simplify the execution of the method for the user, in an embodiment of the invention the positive confirmation of a changed current parameter set is coupled to the save command for a manually post-processed x-ray image. The creation and storage of a copy of the changed current parameter set thus automatically always ensues when the user saves a manually post-processed x-ray image, meaning permanently stores it.

The method then always implements an optimization of its standard setting when a sufficient number of user-specific modified parameter sets exist. The adaptation of the standard parameter set to the optimized parameter set thus only ensues when the number of stored copies reaches a predetermined threshold.

In order to satisfy the different requirements of various medical examinations, various standard parameter sets are kept ready for different organs to be examined, different projection types, and different generator settings. In order to optimize the correct standard parameter set, only those of the stored copies that correspond to the associated organ, the associated projection and the associated generator setting are used for this optimization.

Furthermore, of user profiles or user group profiles can be prepared. For this purpose, respective proprietary standard parameter sets are also maintained for different users or user groups. The storage of the copies of changed parameter sets likewise ensues separately according to the respective user or the respective user group.

An image preparation unit for implementing the inventive method has at least one image processing module that is fashioned to implement a predetermined modification of image data dependent on at least one parameter. This image processing module preferably is a software module that is a component of application software, but it can also be in the form of a physical unit, for example a plug-in card or an integrated circuit. The parameter or parameters is/are provided to the image processing module from a current parameter set that is stored in a buffer (cache) memory. To initialize the buffer memory, a standard memory is provided in which a standard parameter set is stored. Furthermore, a unit allowing user-specific modification of the current parameter set is provided. This unit preferably includes one or more input interfaces such as a keyboard or a mouse, as well as suitable software modules for input support, menu navigation, etc. To store a copy of a modified current parameter set, the image preparation unit has an adaptation module that is fashioned to create an optimized parameter set using the copy or copies stored in the modification memory, and to store this as a new standard parameter set in the standard memory. The buffer memory, the standard memory and the modification memory preferably are separate regions on one or more commonly used storage media, for example the working memory of a computer or a fixed disk.

To create the optimized parameter set, the adaptation module determines the parameter-specific average value of the copes stored in the modification memory according to Eq. 1 and 2.

The image preparation unit preferably has a number of image processing modules, connected in series for successive image processing, that access the current parameter set stored in the buffer memory to obtain the necessary parameters.

The image preparation unit described above is inventively incorporated in an x-ray apparatus. This x-ray apparatus also has an x-ray radiator to generate x-ray radiation and a digital x-ray detector to acquire an x-ray image. This x-ray image is supplied to the inventive image preparation unit in the form of image data.

An advantage of this x-ray apparatus is that no laborious adjustment process must be implemented in the course of its installation, particularly since the x-ray apparatus optimizes its standard settings by self-learning. In addition to the initial installation, this self-learning process is also of advantage if a change of users occurs, particularly since the x-ray apparatus automatically adjusts to the requirements of the new user within a relatively short time.

### DESCRIPTION OF THE DRAWINGS

FIG. 1 is a schematic illustration of an x-ray apparatus with an x-ray radiator, a digital x-ray detector and a control and evaluation system with an image preparation unit, constructed and operating in accordance with the invention.

FIG. 2 shows the x-ray detector of FIG. 1 in a perspective and partially cut away view.

FIG. 3 shows the image preparation unit of the apparatus according to FIG. 1 in a simplified block diagram.

FIG. 4 shows further details of the image preparation unit in a representation according to FIG. 3.

FIG. 5 in an exemplary comparison shows a raw image acquired by the x-ray detector in accordance with the invention, a final image generated in the image preparation unit using a standard parameter set in accordance with the invention, and a modified final image generated by user-specific post-processing in accordance with the invention.

### DESCRIPTION OF THE PREFERRED EMBODIMENTS

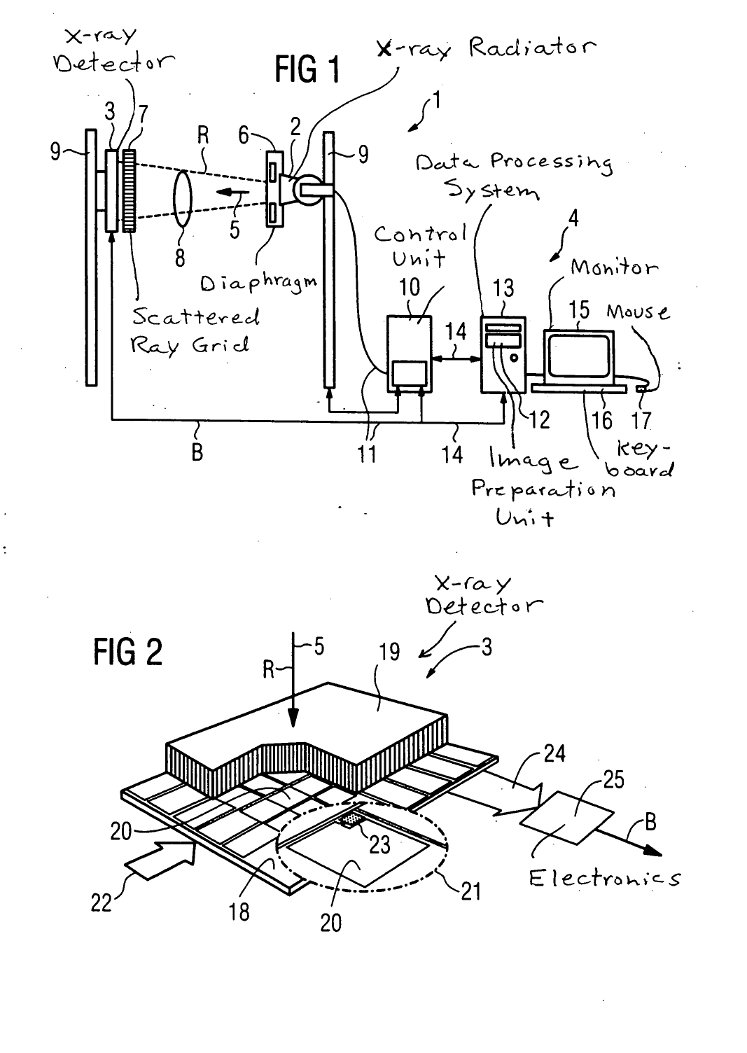

The x-ray apparatus 1 schematically shown in FIG. 1 has an x-ray radiator 2 that emits x-ray radiation R, an x-ray detector 3 and a control and evaluation system 4. A diaphragm 6 and a scattered-ray grid 7 are interposed between the x-ray radiator 2 and the x-ray detector 3. The diaphragm 6 serves to allow selected portion of a desired size of the x-ray radiation R to pass therethrough to a person or a subject 8 to be examined, and to the scattered-ray grid 7 and the x-ray detector 3. The scattered-ray grid 7 serves to gate lateral scattered radiation that would adulterate the x-ray image acquired by the x-ray detector 3.

The x-ray radiator 2 and the x-ray detector 3 are attached to a stand 9 above and below an examination table, such that they can be adjusted.

The control and evaluation system 4 includes a control unit 10 to control the x-ray radiator 2 and/or the x-ray detector 3, and to generate a supply voltage for the x-ray radiator 2. The control unit 10 is connected with the x-ray radiator 2 via data and supply lines. The control and evaluation system 4 furthermore includes an image preparation unit 12. The image preparation unit 12 preferably is a component of a data processing system 13 that, in addition to image processing software, includes operating software for the x-ray apparatus 1. The data processing system 13 is connected with the control unit 10 and the x-ray detector 3 via data and system bus lines 14. For entering and displaying data, the data processing system 13 is connected with peripheral devices, in particular a monitor 15, a keyboard 16 and a mouse 17.

The x-ray detector 3 shown in detail in FIG. 2 is of a type known as a solid-state detector. It has a planar active readout matrix made of amorphous silicon (aSi) that is coated with an x-ray converter layer 19, for example cesium iodide (CsI). In this x-ray converter layer 19, the x-ray radiation R striking in the radiation direction 5 is converted into visible light, which is transduced into electrical charge in photodiodes 20 of the readout matrix 18. This electrical charge is in turn stored spatially resolved in the readout matrix 18. The stored charge, as indicated in the section shown enlarged in FIG. 2, can be read out in the direction of the arrow 24 to electronics 25 (indicated schematically) by electronic activation 22 of a circuit element 23 associated with each photodiode 20. The electronics 24 generates digital image data B with amplification and analog-to-digital conversion of the readout charge. The image data B are transmitted to the image preparation unit 12 via the data and system bus line 14.

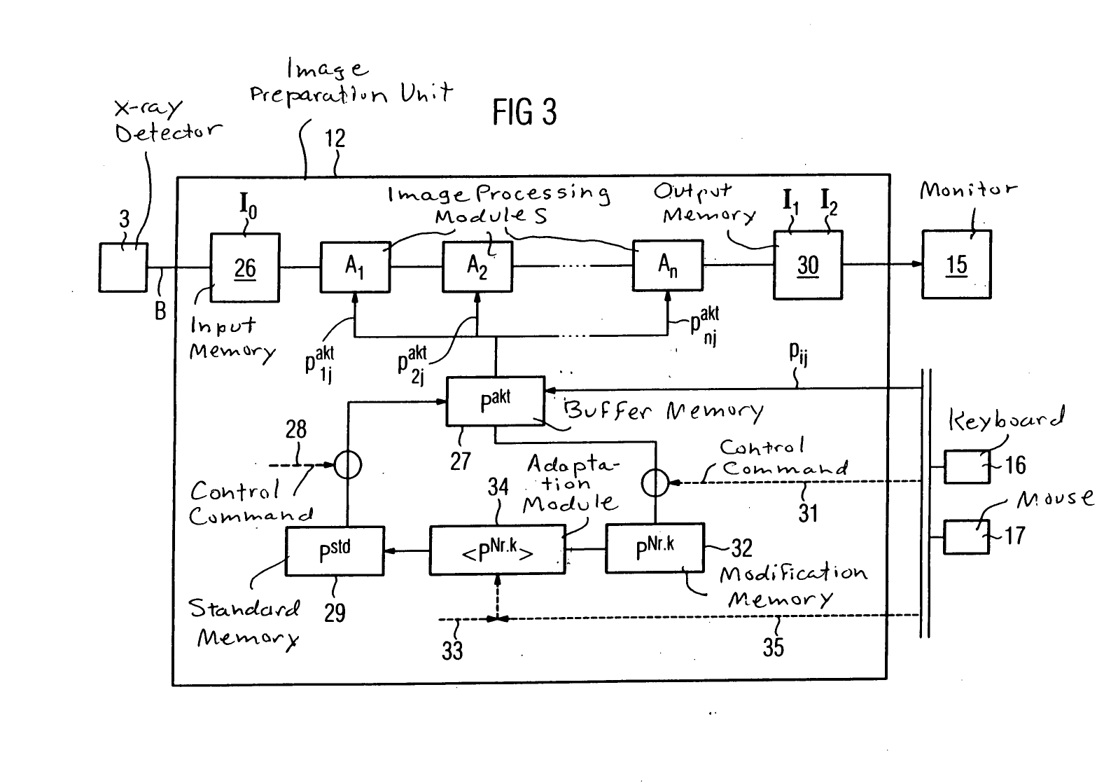

The image preparation unit 12 preferably is in the form of a software module in the data processing system 13. A simplified block diagram of the image preparation unit 12 is shown in FIG. 3. The image data B produced by the x-ray detector 3 are first supplied to an input memory 26. The input memory 26 thus contains image data B representing a “raw image” I₀, meaning an unprocessed x-ray image. Starting from the input memory 26, the image data B are successively supplied to a number of image processing modules Aᵢ (i=1,2, . . . ,n), each of which modifies the image data B in a predetermined manner. The image processing modules Aᵢ are, for example, an image definition module, filter modules (in particular low-pass filter, high-pass filter, median filter and combinations thereof), contrast and brightness modules, frequency-dependent filter modules, or modules for characteristic line-dependent modification of the image data. Each image processing module Aᵢ is controlled by one or more parameters pᵢⱼ (i=1,2, . . . n; j=1,2, . . . mᵢ)

In the example, it is assumed that the first image processing module Aᵢ is a module for contour emphasis (“edge enhancement”). For example, the quantity of the filter kernel, the degree of mixing a high-pass image, a signal level above (or below) which the filter acts or is suppressed, or the like can be used as parameters p₁₁, p₁₂, p₁₃, . . . associated with this module A₁.

Each parameter pᵢⱼ also can contain an individual number or a characteristic line pᵢⱼ(x), meaning a functional dependency.

The entirety of all parameters pᵢⱼ is designated as parameter set P. The parameter set P can be represented, for example, as a two-dimensional field or matrix of the individual parameters pᵢⱼ, or be handled as serial data.

In the operation of the x-ray apparatus 1, a current parameter set P^{akt} is made available to the image processing module Aᵢ. This current parameter set P^{akt} preferably is stored temporarily in a buffer memory 27. The buffer memory 27 can be initialized by a suitable control command 28, meaning allocated with the values of a standard parameter set P^{std}. The standard parameter set P^{std} is in turn stored in a standard memory 29. The control command 28 to initialize the buffer memory 27 ensues at the start-up of the x-ray apparatus 1 or it can be explicitly generated by a user, for example by actuation of a “reset” button. After the initialization, the content of buffer memory 27 is identical to the content of the standard memory 29. The x-ray apparatus 1 thereby operates in its standard setting.

The final image modified by the processing modules Aᵢ corresponding to the setting of the parameters pᵢⱼ is temporarily stored in an output memory 30 and can be displayed on the screen 15. As long as the image preparation unit 12 operates in its standard setting (meaning the current parameter set P^{akt} corresponds to the standard parameter set P^{std}), the modified image stored in the output memory 30 is designated as a standard image I₁. The user now can manually post-process the x-ray image displayed on the screen 15, by changing individual parameters pᵢⱼ relative to the standard setting. For example, the user can implement these changes via the keyboard 16 and operating software (not shown in detail). Based on the changed current parameter set P^{akt}, an image I₂ that is modified relative to the standard image I₁ is generated by the image processing modules Aᵢ, stored in the output memory 30 and displayed on the monitor 15.

When the user is satisfied with the change effected in the x-ray image, the user stores the modified image I₂ permanently. This save event triggers a control command 31 within the image preparation unit 12, based on which a copy P^{Nr.k} (k=1,2, . . . ,K) is stored in a modification memory 32. This event is repeated each time the user saves a modified image I₂. The copies P^{Nr.k} are collected in the modification memory 32. When the number K of the copies P^{Nr.k} collected in the modification memory 32 reaches a predetermined threshold, internally a control command 33 is produced that activates an adaptation module 34 of the image preparation unit 12.

The adaptation module 34 calculates the parameter-specific average value from the parameters Pᵢⱼ^{Nr.k} of the copies P^{Nr.k} according to Eq. 1 or Eq. 2, and thus obtains an optimized parameter set <P^{Nr.k}> that contains the averaged parameter <pᵢⱼ^{Nr.k}>. This optimized parameter set <P^{Nr.k}> is stored as a new standard parameter set P^{std} in the standard memory 29. The adaptation of the standard parameter set P^{std} as described above also can be explicitly initiated by transmission of a manual control command 35 equivalent to the control command 33.

After successful adaptation of the standard parameter set P^{std}, the content of the current parameter set P^{akt} is updated by re-transmission of the control command 28. The standard image I₁ is thus automatically adapted to the taste of the user.

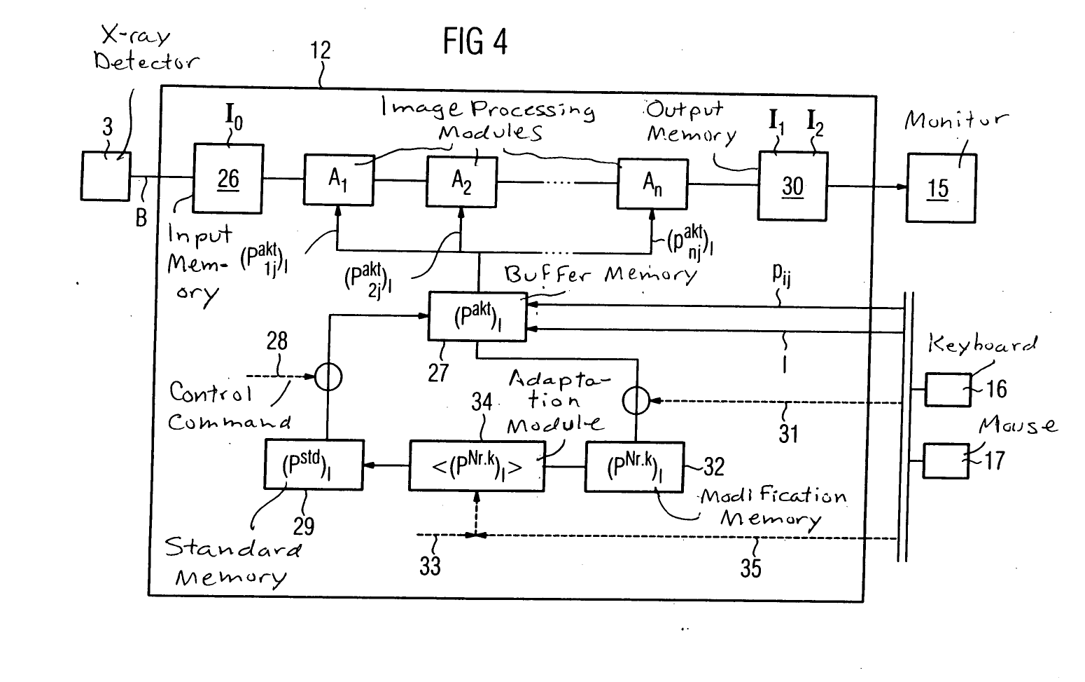

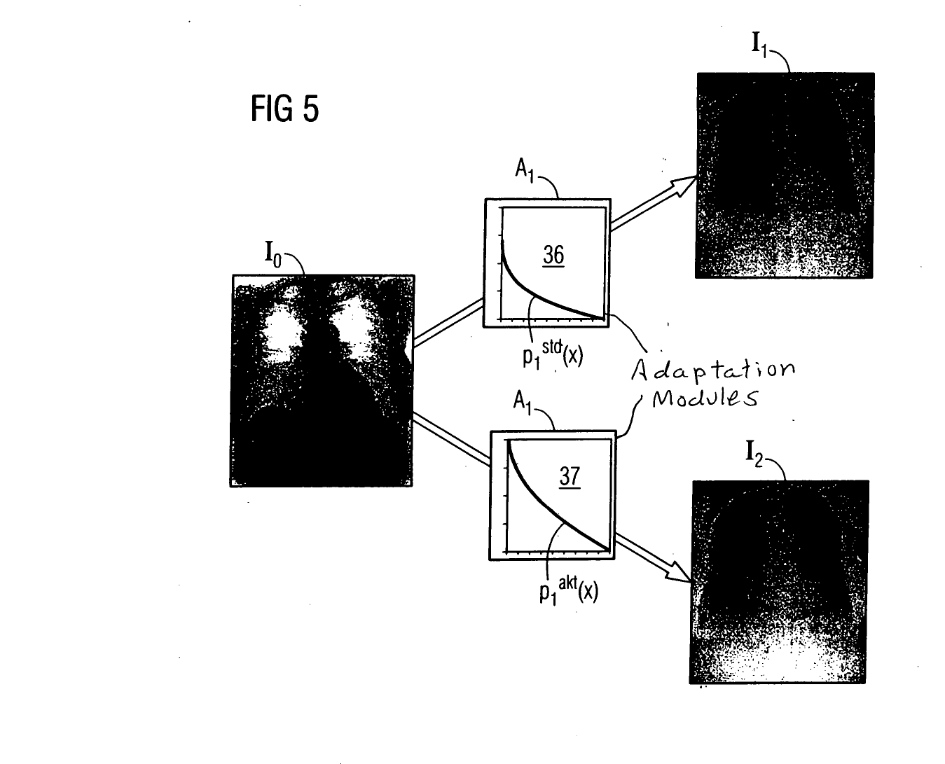

A variant of the image preparation unit 12 shown in FIG. 4 is expanded relative to the embodiment specified in the preceding, to the extent that different standard settings are prepared dependent on the special application of the x-ray apparatus 1. The standard memory 29 accordingly has a number of standard parameter sets (P^{std})_{I} with the count index I=1,2,3, . . . , each individual parameter set (P^{std})_{I} being optimized for an organ to be examined, and/or a specific projection of the x-ray acquisition, and a specific generator setting. Different organs with respectively different standard settings can be, for example, the thorax, hip, abdomen, skull, extremities, etc.; various projections (for example, lateral, aperior-posterior, oblique, etc.). The various generator settings of the x-ray generator differ with regard to the voltage and the current strength of the supply voltage, the filtering or the dose. Furthermore, the image preparation unit 12 offers various person-specific user profiles. This means that different parameter sets (P^{std})_{I} are likewise maintained for different users.

To allow the correct standard parameter set (P^{std})_{I} to be selected for the image preparation, before the test execution, the user specifies the organ to be examined, the projection used and the generator setting, and enters his or her user identification. From this, the operating software determines the associated count index I, using which the associated standard parameter set (P^{std})_{I} is identified.

The functioning of the image preparation unit 12 according to FIG. 4 corresponds to the embodiment of FIG. 3, but with the current parameter set (P^{akt}), and each stored copy (P^{Nr.k})_{I} thereof, corresponding to the standard parameter set (P^{std})_{I}, are being dependent on the count index I.

For proper functioning of the optimization process, that the adaptation module 34 for averaging uses only those copies (P^{Nr.k})_{I} that correspond to the count index I.

For comparison, FIG. 5 shows an image (acquired by the x-ray detector 3) of a human ribcage (thorax) in the form of a raw image I₀, a standard image I₁ and a manually modified image I₂. For image preparation, a processing module A₁ was used that effects a grey-value shift of the individual pixels according to a characteristic line p₁(x). The upper graph 36 in the representation shows a characteristic line p₁^{std}(x) corresponding to the standard setting. In contrast, the lower graph 37 shows a manually changed characteristic line p₁^{akt}(x).

Although modifications and changes may be suggested by those skilled in the art, it is the intention of the inventor to embody within the patent warranted hereon all changes and modifications as reasonably and properly come within the scope of his contribution to the art.

I claim as my invention:

1. A method for preparing a digital x-ray image from raw image data, comprising the steps of:
supplying raw image data to an electronic image processing module;
initializing a current parameter set, containing at least one parameter, using a standard parameter set; allowing manual modification of said current parameter set for obtaining a modified parameter set and using said modified parameter set in said image processing module for electronically processing said raw image data;
generating a confirmation of said manual modification and, upon generation of said confirmation, storing a copy of said modified parameter set;
electronically generating an optimized parameter set dependent on the stored modified parameter set; and
adapting said standard parameter set to said optimized parameter set.

2. A method as claimed in claim 1 comprising respective manually modifying a plurality of different current parameter sets for obtaining a plurality of modified parameter sets, and storing a copy of each of said plurality of modified parameter sets, and electronically generating said optimized parameter set as a parameter-specific average value of said plurality of stored copies of modified parameter sets.

3. A method as claimed in claim 2 comprising automatically generating said optimized parameter set when a number of the stored copies of said modified parameter sets reaches a predetermined threshold.

4. A method as claimed in claim 1 comprising automatically triggering generation of said confirmation upon saving the modified parameter set.

5. A method as claimed in claim 1 comprising storing a plurality of standard parameter sets respectively for a plurality of different organs and, for each organ in said plurality of organs, obtaining and storing at least one modified parameter set, and, for raw image data representing one of said plurality of different organs, using only the stored modified parameter sets for said one of said different organs for generating said optimized parameter set.

6. A method as claimed in claim 1 comprising storing a plurality of standard parameter sets respectively for a plurality of different image projections and, for each image projection in said plurality of image projections, obtaining and storing at least one modified parameter set, and, for raw image data representing one of said plurality of different image projections, using only the stored modified parameter sets for said one of said different image projections for generating said optimized parameter set.

7. A method as claimed in claim 1 wherein said raw image data are obtained using an x-ray image acquisition system having setting associated therewith, and storing a plurality of standard parameter sets respectively for different settings and, for each setting, obtaining and storing a modified parameter set, and for raw image data obtained with said x-ray image acquisition system at one of said settings, generating said optimized parameter set using only the stored modified parameter sets for said one of said settings.

8. A method as claimed in claim 1 comprising allowing different users to manually modify said current parameter set for obtaining and storing, for each of said users, at least one modified parameter set, storing respective standard parameter sets respectively for said different users, and for one of said users, generating said optimized parameter set using said at least one stored modified parameter set for said one of said users.

9. In an x-ray apparatus that acquires raw image data, the improvement of an image preparation unit for preparing a digital x-ray image from the raw image data, comprising:
an electronic image processing module supplied with said raw image data;
a buffer memory, accessible by said electronic image processing module, containing a current parameter set, containing at least one parameter;
a standard memory connected to said buffer memory for initializing said current parameter set in said buffer memory with a standard parameter set stored in said standard memory;
an input unit connected to said electronic image processing module allowing manual modification of said current parameter set for obtaining a modified parameter set for use by said image processing module to process said raw image data;
a modification memory for storing a copy of said modified parameter set upon generation of a confirmation; and
an adaptation unit connected to said modification memory and said standard memory for generating an optimized parameter set dependent on the stored modified parameter set and for adapting said standard parameter set to said optimized parameter set.

10. The improvement of claim 9 wherein said modification memory contains a plurality of stored copies of modified parameter sets respectively obtained for different manual modifications of said current parameter set, and wherein said adaptation unit generates said optimized parameter set as a parameter-specific average of said plurality of stored copies of modified parameter sets.

11. The improvement of claim 9 comprising a plurality of electronic image processing modules connected in series, each connected to said standard memory, said standard memory containing a plurality of respective standard parameter sets for said image processing modules.

12. An x-ray apparatus comprising:
an x-ray source that emits x-ray radiation;
a radiation detector on which said x-ray radiation, after being attenuated by a subject, is incident, said radiation detector generating raw image data of the subject dependent on the x-ray radiation incident thereon;
an electronic image processing module supplied with said raw image data;
a buffer memory, accessible by said electronic image processing module, containing a current parameter set, containing at least one parameter;
a standard memory connected to said buffer memory for initializing said current parameter set in said buffer memory with a standard parameter set stored in said standard memory;
an input unit connected to said electronic image processing module allowing manual modification of said current parameter set for obtaining a modified parameter set for use by said image processing module to process said raw image data;
a modification memory for storing a copy of said modified parameter set upon generation of a confirmation; and
an adaptation unit connected to said modification memory and said standard memory for generating an optimized parameter set dependent on the stored modified parameter set and for adapting said standard parameter set to said optimized parameter set.

13. An x-ray apparatus as claimed in claim 12 wherein said radiation detector is a solid-state detector having an active readout matrix composed of amorphous silicon.
